(19) United States
(12) Patent Application Publication
(10) Pub. No.: US 2021/0041632 A1
(43) Pub. Date: Feb. 11, 2021

(54) Connection Assembly and Method of Connecting Composite Rods

(71) Applicant: Ziebel AS, Tananger (NO)

(72) Inventor: Anton Antonarulrajah, Sandnes (NO)

(21) Appl. No.: 17/045,937

(22) PCT Filed: Apr. 9, 2019
(86) PCT No.: PCT/GB2019/051027

§ 371 Date: Oct. 7, 2020

(30) Foreign Application Priority Data
Apr. 19, 2018 (GB) 1805872.7

(51) Int. Cl. G02B 6/255; G02B 6/245; E21B 17/04; E21B 17/10

(52) U.S. Cl. CPC G02B 6/2558; G02B 6/245; E21B 17/10; E21B 17/04; G02B 6/2555

(57) ABSTRACT

A method for making a connection between an end of a first composite rod (10) and an end of a second composite rod (10) comprises removing material from an outer surface of the composite material surrounding optical fibre (11) adjacent an end of the first and second composite rods (10, 20) to form at least one shoulder on each of the first and second composite rods (10, 20); connecting the optical fibres (11) between the first and second composite rods (11); clamping the ends of the first and second composite rods within two clamp devices (40) such that the shoulders of the first and second composite rods (10, 20) engage with shoulders of the clamp devices (40); connecting the clamp devices (40); and bonding the first and second composite rods (10, 20) to the first and second clamp devices (40).

### FIELD OF THE INVENTION

The present application relates to composite rods used in wellbores, and to a method of connecting the ends of two composite rods containing an optical fibre.

### BACKGROUND

U.S. Pat. No. 7,769,260 (the disclosure of which is incorporated herein by reference) discloses an intervention rod having an optical fibre which is embedded within a surrounding stiff layer of composite material. Rods such as these are inserted into the wellbore of an oil or gas well in order to perform some purpose, for example to deliver tools to a location in the well, or to determine local environmental parameters in the wellbore such as temperature along the length of the rod. The rods are generally resistant to axial extension or compression, allowing the rods to be pushed or pulled within the wellbore, but they retain lateral flexibility, permitting the rods to bend within the wellbore as it deviates from a straight line.

U.S. Pat. No. 5,798,153 and GB1478705 are useful for understanding the invention, and are incorporated herein by reference.

### SUMMARY

The invention provides a method for making a connection between an end of a first composite rod and an end of a second composite rod, the first and second composite rods each being suitable for insertion into a wellbore of an oil or gas well and each rod comprising an optical fibre embedded within a composite material, wherein the ends of the first and second composite rods each comprise an exposed length of optical fibre extending from a length of composite material, the method comprising:
removing material from the outer surface of the composite material surrounding the optical fibre adjacent the end of the first and second composite rods to form at least one shoulder on the outer surface of the composite material of each of the first and second composite rods;
connecting the optical fibres extending from the ends of the first and second composite rods to form a continuous optical fibre conduit between the first and second composite rods;
applying a first clamp device to the end of the first composite rod and applying a second clamp device to the end of the second composite rod, each clamp device having at least one shoulder adapted to engage with the shoulder on the outer surface of the first and second composite rods;
clamping the ends of the first and second composite rods within the first and second clamp devices such that the shoulders of the first and second composite rods engage with the shoulders of the first and second clamp devices;
connecting the first and second clamp devices; and
bonding the first and second composite rods to the first and second clamp devices with an adhesive.

Optionally the method includes connecting the first and second clamp devices with a spacer formed from composite material. Optionally the first and second clamp devices clamp opposite ends of the spacer at one end (e.g. respective inner ends) of the clamp devices, and clamp the respective ends of the first and second rods at the other ends (e.g. respective outer ends) of the clamp devices.

Optionally the method includes removing material from an outer surface of the composite material of the spacer adjacent each end of the spacer to form at least one shoulder on the outer surface of each end of the spacer. Optionally the method includes clamping the shoulders on each end of the spacer within the first and second clamp devices. The details of the formation and use of the shoulder on the spacer is optionally the same as described for the first and second composite rods.

Optionally the spacer comprises a channel adapted to receive the optical fibre. Optionally the channel comprises a groove, optionally extending along the length of the spacer. The groove can optionally have a U-shaped section profile, optionally with one open side. Optionally the open side of the channel is closed by filling the channel with composite material, optionally by building up or laying sequential layers of composite material in the channel optionally so that the channel is filled in and the spacer has a uniform outer diameter.

In some cases, one of the first and second composite rods may already comprise a length of exposed optical fibre ready for connection to the optical fibre from the other of the first and second composite rods, but optionally the method includes removing material from an outer surface of the composite material at one (or each) of the first and second composite rods to expose the optical fibre embedded in the composite rod, optionally to the extent necessary to connect the exposed optical fibre extending from the ends of the first and second composite rods. The step is optionally performed by machining the outer surface to remove material, for example, by grinding, abrading, cutting or otherwise removing the composite material thereby typically reducing the outer diameter of the outer surface of the composite material until the optical fibre is exposed.

Optionally the composite material can be removed entirely from the area surrounding the exposed optical fibre, but in some examples, sufficient composite material can be removed to perform the step of connecting the optical fibres. Optionally the faces of the composite material on the ends of the first and second rods from which the exposed optical fibres extend can be flat, and optionally parallel, and optionally perpendicular to the axis.

Removing composite material to expose the optical fibre can be useful if insufficient optical fibre is exposed at the first and/or second ends to enable a satisfactory connection between the exposed ends of optical fibre.

The method steps can be carried out in any logical order and are not restricted to the order in which they are presented herein. However, optionally the step of removing material from the outer surface of the composite material to form the shoulder is performed before the application of the clamp device. The step is optionally performed by machining the outer surface to remove material, for example, by grinding, abrading, cutting or otherwise removing the composite material thereby typically reducing the outer diameter of the outer surface of the composite material.

Optionally the optical fibres are connected to form a continuous conduit before connecting the rods (e.g. by the spacer).

The shoulder optionally has at least one flat face (optionally at least two spaced apart flat faces), which is optionally perpendicular to an axis of the first and second composite rods, which are optionally co-axial with each other, and co-axial with the clamp device. Optionally at least two shoulders are formed (e.g. machined) in each of the ends of the composite rods and/or the spacer. Optionally the shoulder can be annular, extending around at least a part of (optionally fully around) the circumference of the ends of the composite rods and/or the spacer. Optionally the or each shoulder can have a plateau section, connecting flat faces extending perpendicularly with respect to the axis. The plateau section can optionally be generally parallel with the axis. The flat face(s) of the shoulder helps to transfer axial forces more reliably across the connection.

In one example, the ends of the composite rod are adhered together with adhesive injected into the clamp device. Optionally the adhesive bonds the faces of the shoulders.

Optionally the clamp device comprises two clamp members adapted to close together on application of a clamping force. Optionally the clamp members can be connected by fixings with screw threads, so that driving e.g. a nut on a screw thread applies a clamping force between the clamp members. Optionally the clamp members are symmetrical around the axis of the clamp device. Optionally each clamp member has the same profile of shoulder, and a portion of the shoulder is optionally formed on each clamp member. Optionally the clamp device comprises a tubular device having a central bore adapted to receive the optical fibre, and at least a part of each of the first and second rods.

Optionally the optical fibre is encased in a metal tube. Optionally the metal tube is removed around the terminal ends of the optical fibre to permit the connection of the optical fibre between the two ends. Optionally the optical fibre is connected between the ends of the first and second composite rods by a mechanical splice device such as is described in U.S. Pat. No. 5,189,717 or 5,682,450 (the disclosure of each of these is incorporated herein by reference). Optionally the optical fibre is covered by a metal tube slid over the connected ends of the optical fibres. Optionally the optical fibres are surrounded by a polymerisable material such as a gel within the tube, which can optionally be injected into the tube following assembly.

In some examples, the clamp device can comprise a metal. In some examples, the clamp device can have the same or a similar (within 10%, optionally within 5%) value of Young's modulus as that of the first and second rods. Optionally the clamp device can have the same or a similar (within 10%, optionally within 5%) reaction to lateral forces as the first and second rods. Optionally the reaction of the spacer to lateral forces and optionally the Young's modulus of the spacer can also be substantially the same or similar (within 10%, optionally within 5%) as that of the first and second rods. Optionally the clamp device and the assembly incorporating the clamp device can be reeled without lateral or axial deviation of the assembly at the clamp device. In some examples the material of the clamp device comprises titanium or an alloy thereof.

Optionally the outer diameter of the assembled clamp device is substantially the same as or is similar to (within 10%, optionally within 5%) the outer diameter of the first and second rod, which is optionally the same as the spacer. The assembly can optionally pass through pressure control equipment in a well without losing pressure as the line transitions in sequence from the first rod, to a clamp device, (optionally to the spacer and to another clamp device) and to the second rod.

The invention also provides a connection assembly comprising:
a first composite rod having an end and a second composite rod having an end, the first and second composite rods each being suitable for insertion into a wellbore of an oil or gas well, and comprising an optical fibre embedded within a composite material, wherein the optical fibre within each of the first and second composite rods is connected between the ends of the first and second rods to form a continuous optical fibre conduit between the first and second composite rods;
the ends of the first and second rods each having at least one shoulder extending radially into the outer surface of the composite material surrounding the optical fibre;
at least one clamp device having a shoulder clamped onto at least one of the first and second rods such that the shoulder on the said at least one of the first and second rods engages with the shoulder of the clamp device; and
wherein the at least one of the first and second rods is bonded to the clamp device with an adhesive.

The invention also provides a method for making a connection between an end of a first composite rod and an end of a second composite rod, the first and second composite rods each being suitable for insertion into a wellbore of an oil or gas well, and each rod comprising an optical fibre embedded within a composite material, wherein the end of each of the first and second composite rod comprises an exposed length of optical fibre extending from a length of composite material, the method comprising:
removing material from the outer surface of the composite material surrounding the optical fibre adjacent the end of the first and second composite rod to form at least one shoulder on the outer surface of the composite material of the first and second composite rods;
connecting the optical fibres extending from the ends of the first and second composite rods to form a continuous optical fibre conduit between the first and second composite rods;
clamping the end of the first and second composite rods within a clamp device having at least one shoulder such that the shoulders of the first and second rods engage with the shoulder of the clamp device; and
bonding the first and second rods to the clamp device with an adhesive.

Optionally the same clamp device extends between the two ends of the first and second composite rods.

The invention also provides a method for making a connection to an end of a composite rod being suitable for insertion into a wellbore of an oil or gas well, the composite rod comprising an optical fibre embedded within a composite material, wherein the end of the composite rod comprises an exposed length of optical fibre extending from a length of composite material, the method comprising:
removing material from the outer surface of the composite material surrounding the optical fibre adjacent the end of the composite rod to form at least one shoulder on the outer surface of the composite material of the composite rod;
connecting the optical fibres extending from the end of the composite rod to optical fibres on the other side of the connection to form a continuous optical fibre conduit;
clamping the end of the composite rod within a clamp device having at least one shoulder such that the shoulder of the composite rod engages with the shoulder of the clamp device; and
bonding the composite rod to the clamp device with an adhesive.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. In particular, unless otherwise stated, dimensions and numerical values included herein are presented as examples illustrating one possible aspect of the claimed subject matter, without limiting the disclosure to the particular dimensions or values recited. All numerical values in this disclosure are understood as being modified by “about”. All singular forms of elements, or any other components described herein are understood to include plural forms thereof and vice versa.

Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee. In particular, positional references in relation to the well such as “up” and similar terms will be interpreted to refer to a direction toward the point of entry of the borehole into the ground or the seabed, and “down” and similar terms will be interpreted to refer to a direction away from the point of entry, whether the well being referred to is a conventional vertical well or a deviated well.

### BRIEF DESCRIPTION OF THE DRAWINGS

In the accompanying drawings:

FIG. 1 shows a side sectional view of first and second composite rods to be joined;

FIGS. 2 to 6 show sequential steps preparing the first and second composite rods of FIG. 1 for connection;

FIG. 7 shows a side and in view of a spacer used in the connection;

FIG. 8 shows a side sectional view similar to FIGS. 1 to 6, with the spacer of FIG. 7 in place in the connection;

FIG. 9 shows an end sectional view through the spacer of the assembly shown in FIG. 8;

FIG. 10 shows a perspective view of a clamp device;

FIG. 11 shows the preparation of the opposed ends of the first and second composite rods before application of the clamp device, which is shown in FIG. 12; and

FIG. 13 shows an assembly of the first and second composite rods interconnected by the spacer of FIG. 8 and two clamp devices as shown in FIG. 10.

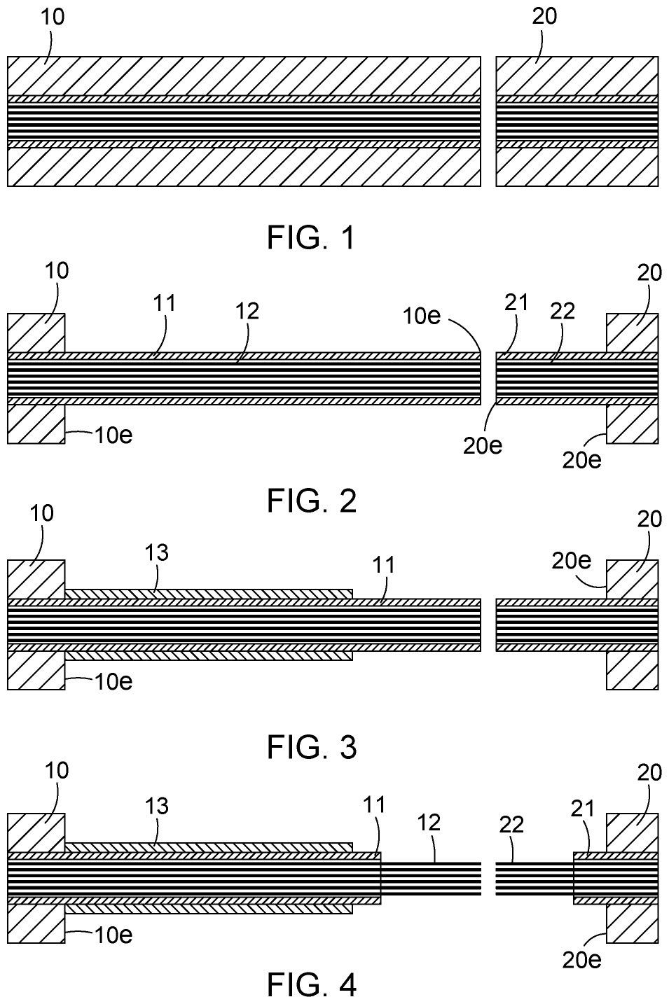

Turning now to the drawings, first and second composite rods 10, 20 are shown in FIG. 1 being placed end to end at a splice location. Each composite rod 10, 20 has an array of optical fibres 12, 22 which in this example are encased within metal tubes 11, 21 along an axis of the rod 10, 20. Surrounding the metal tubes 11, 21, the body of each rod comprises a composite material, such as a fibre combined with a resin. Different fibres and resins can be used, but one option which is used in this case is the combination of carbon fibre with a suitable resin, such as EPON Resin 9310 from Resolution Performance Products LLC (USA) or alternatively Resin XB 9721 from Huntsman Advanced Materials (USA), but many other resins are suitable. Optionally, the fibres in the composite material are aligned with the axis of the rods.

The first step in the preparation of the rods 10, 20 for connection is the removal of at least a part of the layer of composite material from the outer surface of the metal tubes 11, 21 to expose opposing ends 10e, 20e of the first and second rods 10, 20 for connection as shown in FIG. 2, and to expose the metal tubes 11, 21 which extend from the ends 10e, 20e. In some examples, the rods to be connected will already have exposed lengths of optical fibres and tubes ready to be connected, but in this case, the ends of the rods 10, 20 have been cut with flat and perpendicular ends, as shown in FIG. 1, to cut out a fault in a single rod, or to connect one end of one rod to another to form a continuous rod of longer length.

Optionally, as is shown in FIG. 2, a longer length of the composite wall is removed on one of the rods, e.g. the first rod 10, than on the other rod 20, so that the metal tube 11 and array of fibre-optic conduits 12 extending from the end 10e is longer than the metal tube 21 and array of fibre-optic conduits 22 extending from the end 20e of the second rod 20. Optionally, the faces of ends 10e, 20e are mutually parallel, and optionally perpendicular to the axis of the rods 10, 20, but this is not essential.

Once the composite material has been removed from the outer surface of the metal tube 11, 21 on the end of each rod 10, 20, a bridging sleeve 13, optionally in this example in the form of a metal tube, formed from, e.g. stainless steel with a slightly larger diameter than the tubes 11, 21, and having an inner diameter sufficient to receive the outer diameter of the tubes 11, 21 in a tight fit, is placed (e.g. slid) over the metal tube 11 on the longer of the two sides of metal tube and optical fibre extending from the two ends 10e, 20e.

After sliding the bridging sleeve 13 axially in place over the metal tube 11, the optical fibres 12, 22 on each side of the connection are then exposed as shown in FIG. 4 by removing the metal tube 11, 21 surrounding them. This can be done by cutting back the metal tube 11, 22 by a short distance to expose the individual optical fibres 12, 22 between the two ends 10e, 20e, ready for splicing them together.

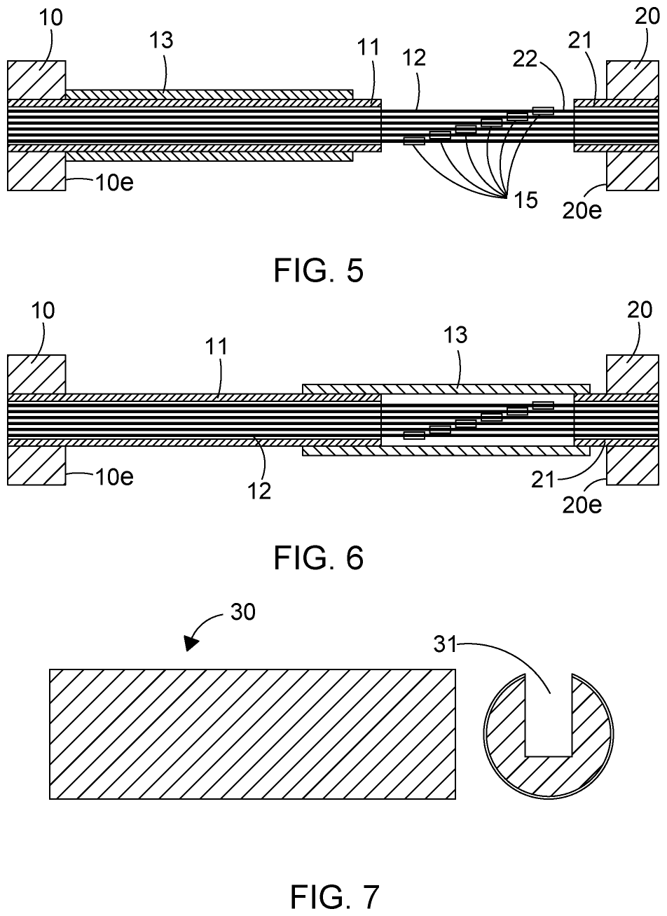

As shown in FIG. 5, the optical fibres 12, 22 are then individually spliced at 15 to connect the optical fibres 12 to the optical fibres 22, and create a continuous conduit between the fibres 12, 22. Optionally each fibre 12, 22 end is stripped of any external coating, optionally using a thermal fibre stripper. Individual pairs of fibres 12, 22 from respective rods 10, 20 are then connected by fusion splicing. After fusion splicing each fibre is then recoated and optionally sleeved. The last step of restoring the coating and applying the optional sleeve optionally returns the fibre strands to their original outer diameter. As shown in FIG. 5, the connections at 15 between the fibres 12, 22 are optionally staggered axially between the cut ends of the tubes 11, 21, which reduces the required diameter of the bridging sleeve 13.

Once the optical fibres 12, 22 are connected as shown in FIG. 5, the bridging sleeve 13 is slid axially over the connection to bridge the two cut ends of the tubes 11, 21 as shown in FIG. 6, and is sealed in place with a suitable adhesive, such as epoxy, between the bridging sleeve 13 and the exposed ends of the cut tubes 11, 21. Optionally, before sealing, the inner bore of the bridging sleeve 13 can be injected with a suitable thixotropic gel which optionally reduces or prevents movement of well fluids through the metal tube in the case of a loss of seal while in the well due to a pressure breach or breakage of the connection.

Once the bridging sleeve 13 is sealed in place, the gap between the two ends 10e, 20e of the composite rods 10, 20 is filled by a spacer 30 are shown in FIG. 7. Optionally, the spacer 30 has a channel 31, optionally in the form of a general U-shape, with dimensions sufficient to accommodate the bridging sleeve 13 encasing the connectors 15 in the position substantially coaxial with the first and second rods 10, 20, so that the bridging sleeve 13 can pass through the channel without bending. As shown in FIG. 8, the spacer 30 is positioned between the ends 10e, 20e, with the bridging sleeve 13 and tubes 11, 21 passing through an opening of the channel 31 in a side wall of the spacer 30.

After the spacer 30 is in place between the ends 10e, 20e, and the interconnected arrays of optical fibres 12, 22 within the tubes 11, 21 and bridging sleeve 13 are axially positioned within the channel 13 of the spacer 30, the channel 31 is filled-in around the bridging sleeve with a composite material to build up the wall of the spacer up to the nominal diameter. This is optionally achieved by layering composite material within the channel 31 in stages over the top of or around the bridging sleeve 13. Optionally, lengths of fibre and resin material are positioned within the channel 31, and the cross-section of composite material within the channel 31 is built-up in a radial direction until the composite material filled into the channel 31 extends slightly proud of the opening of the channel 31. The composite material filled into the channel is allowed to cure, and the outer surface of the spacer 30 at the opening of the channel 31 is then machined back to a generally circular configuration, as shown in FIG. 9.

When the channel 31 has been filled in with composite material and the spacer returned to a circular cross-section, and the assembly of the first and second rods 10, 20 and the spacer 30 are in the configurations shown in FIG. 9, the first and second ends 10e, 20e are ready to be connected to opposite ends of the spacer 30. This is optionally accomplished by a respective clamp device at each end of the spacer 30, connecting the opposite ends of the spacer 30 to the opposed ends 10e, 20e of the first and second composite rods 10, 20.

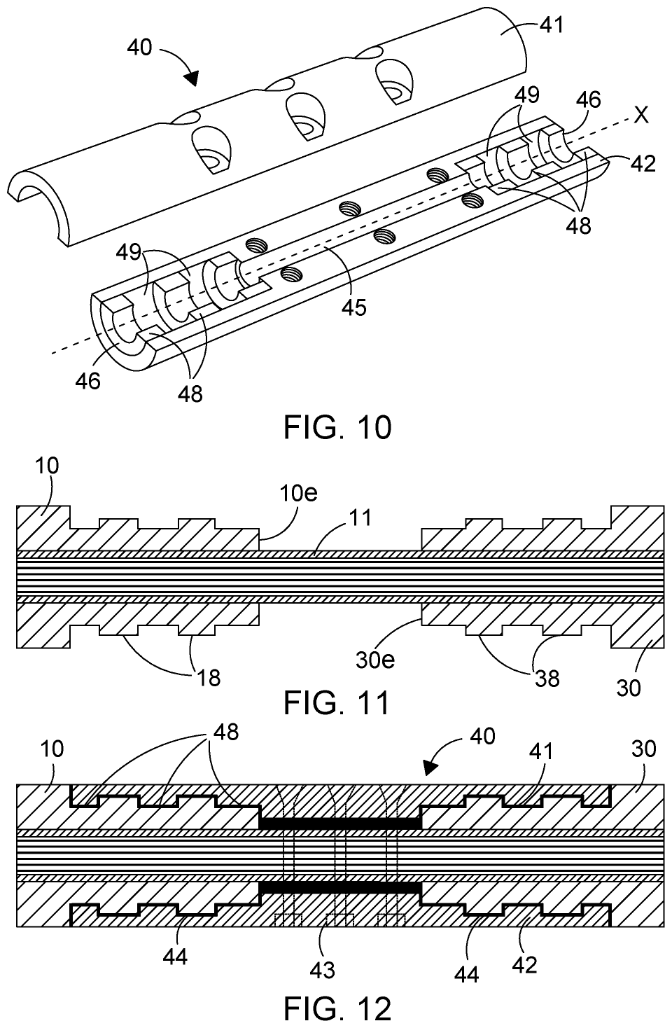

The clamp device 40 is shown in the sectional view in FIG. 12, and in perspective view in FIG. 10. In this example, the clamp device 40 comprises separate shells 41, 42, although more than two shells can be used, and the shells need not be the same size. The shells 41, 42 connect along a plane that is co-axial with the central axis X-X and this divides the clamp device 40 into generally identical shells in this case, which optionally differ only in that the lower shell 42 has threaded sockets to receive fixings such as bolts, whereas the upper shell 41 has plain apertures through which the fixings can pass. The sockets on the lower shell 42 and the apertures on the upper shell 41 are aligned on opposite sides of a narrow central channel 45 passing coaxially between relatively wide end chambers 46 in a central section of the clamp device 40. In the assembled clamp device, the central channel 45 is just wide enough to accommodate the bridging sleeve 13 and metal tubes 11, 21 extending axially between the spacer 30 and the two ends 10e, 20e of the first and second rods 10, 20.

The end chambers 46 accommodate a portion of the composite wall of the spacer 30 and the first and second rods 10, 20. The end chambers 46 each have annular ribs 48 extending circumferentially around the inner surface of each end chamber 46. The annular ribs 48 are mutually parallel, and spaced apart along the axis. The ribs 48 are, in this example, generally rectangular in cross-section, as can be best observed in FIG. 10. Each of the shells 41, 42 has a matching set of half-ribs 48, which line up and combine to form single ribs in the made up clamp device. The ribs 48 have axially spaced radial sides, forming shoulders which extend radially inwardly from the inner surface of the end chambers 46. In this example the sides forming the shoulders are perpendicular to the axis X-X of the clamp device 40. Each rib 48 provides two shoulders, one on each side of the rib 48. The ribs 48 also define recesses 49 between the ribs 48.

Before the clamp device 40 is applied to the assembly of the spacer 30 and the first and second rods 10, 20, the outer surface of the composite material on the ends 10e, 20e of the first and second rods 10, 20 and the opposing ends of the spacer 30 are machined in order to remove composite material from the outer surface, and to create spaced apart ribs 18 on the reduced diameter section of the rod 10, spaced apart ribs 28 on the reduced diameter section of the rod 20, and spaced apart ribs 38 on each opposed end of the spacer 30. The ribs 18, 28, 38 are optionally identical, concentric and parallel, and are spaced apart axially so that in the assembly they line up with and optionally fill the recesses 49 between the ribs 48 on the clamp device 40. The ribs 18, 28, 38 have shoulders on their radially extending side faces, which are optionally at matching angles with the shoulders on the side faces of the ribs 48. The ribs 18, 28, 38 in this example are dimensioned to be received in the recesses 49 between the ribs 48 on the clamp device 40, optionally in a tight fitting arrangement.

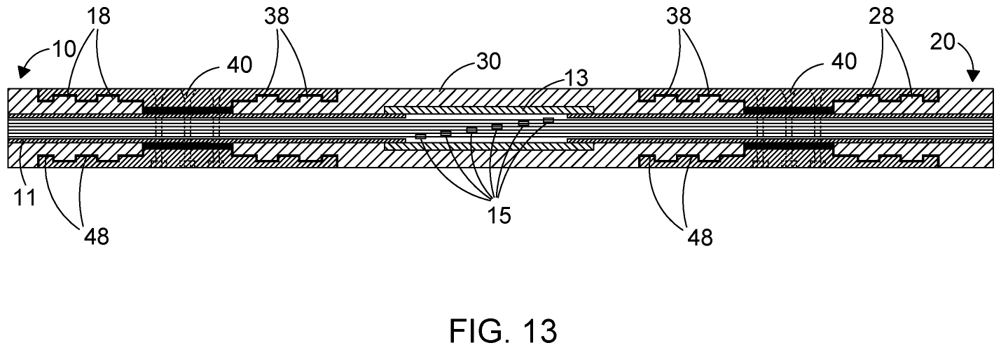

Once the outer surface of the ends 10e, 20e of the rods 10, 20 and the opposite ends of the spacer 30 are machined into the correct shape with the ribs 18, 28, 38, the two shells of the clamp device 40 are assembled over the ends of the rods and spacer 30 so that the ribs 18, 38 on the rod 10 and spacer 30 are lined up with the recesses 49 between the ribs 48 on the clamp device 40, and so that the axially facing shoulders on the side faces of the ribs 18, 38 and 48 are engaged together. The rod 20 is connected to the other end of the spacer 30 in the same manner (only one end of the spacer is shown in FIGS. 11 & 12). The two shells 41, 42 are then connected by fixings 43 such as bolts which are then tightened to apply a clamping force between the two shells, and drive the interlocking ribs 18, 28, 38 and 48 into engagement. The assembly then has the configuration shown in FIG. 13, and adhesive can either be injected between the interlocking faces after connection, but in this example, the adhesive is applied to the interlocking faces before connection (the adhesive distribution is shown in thick black lines in FIG. 13). After connection, the outer surface of the clamp device 40 is substantially flush with the outer surface of the rods 10, 20 and the spacer 30, so that there is no radial deviation of the outer surface of the assembly as it transitions from the rod 10 to the spacer 30 and to the rod 20.

In this example, the clamp device 40 is formed from a metal, which optionally has the same or a similar (within 10%) value of Young's modulus as that of the rods 10, 20 and optionally the spacer 30. A suitable material for the clamp device in this example is titanium or an alloy thereof. In this example, the titanium material of the clamp device 40 has a Young's modulus of 119 GPa comparing with the equivalent value for the carbon fibre material of the rods and spacer which is 123 GPa.

Optionally the clamp device has the same reaction to lateral forces as the rods 10, 20 and optionally the spacer 30, and can therefore be reeled without deviation of the assembly at the clamp device 40. Optionally the yield strength (the stress at which the material begins to deform plastically) of the material of the clamp device and the compression failure strength of the composite material in the rod is also substantially (within 10%) the same, and in this case, the value of each is around 950 MPa.

In this example, the ridges 18, 28, 38 had an axial length of approximately 10-20 mm, e.g. 15 mm and a radial depth of approximately 1-2 mm, e.g. 1.2 mm, and the recesses between the ribs 18, 28, 38 had an axial spacing between adjacent ridges or between the first ridge and the end of the rod of approximately 20-35 mm, e.g. 28 mm. The axial length of the central portion was approximately 50-100 mm, e.g. 72 mm, and the axial length of the end chambers 48 was approximately 100-130 mm, e.g. 114 mm giving an overall length of approximately 250-350 mm, e.g. 300 mm, with an external rod OD of approximately 10-30 mm, e.g. 15 mm. These dimensions and materials allowed a failure load of approximately 10,000 kg over the titanium clamp device 40. The dimensions were determined such that the desired yield strength of the minimum cross section of the clamp device was matched (within 10%) by the force required to shear the adhesive connection between the machined rod surface and the shells of the clamp device.

Optionally, the length of the outer channel and the number of ribs can be adjusted to provide different gripping and bonding areas between the rods and the clamp device. The outer surfaces of the rods can optionally be machined to a dimension that is less than the inner surfaces of the clamp device, leaving an empty space between the outer surface of the rods and the inner surfaces of the clamp device, which is filled with adhesive in the final assembly. The dimensions of the layer of empty space can be determined by the bonding characteristics of the adhesive, and typically the bonding area is calculated to be as strong as the weakest part of the clamp device 40. A suitable adhesive is Loctite™ EA9394 available from Henkel Corporation of Stamford Conn., USA, which has a shear strength of approximately 34.5 MPa.

In the present example, the outer surface of the clamp device 40 can optionally be limited to the maximum diameter of the rods 10, 20, e.g. 15 mm, which permits the assembly including the clamp device 40 to pass through a pressure control head in the well. After connection of the assembly the connected rods 10, 20 optionally behave as a single rod with no lateral deviation or axial compression or extension of the connection between the rods 10, 20 as the connected rods are reeled onto a reel, or pushed or pulled through the wellbore.

What is claimed is:

1-22. (canceled)

23. A method for making a connection between an end of a first composite rod and an end of a second composite rod, the first and second composite rods each being suitable for insertion into a wellbore of an oil or gas well and each rod comprising an optical fibre embedded within a composite material, wherein the ends of the first and second composite rods each comprise an exposed length of optical fibre extending from a length of composite material, the method comprising:
removing material from the outer surface of the composite material surrounding the optical fibre adjacent the ends of the first and second composite rods to form at least one shoulder on the outer surface of the composite material of each of the first and second composite rods;
connecting the optical fibres extending from the ends of the first and second composite rods to form a continuous optical fibre conduit between the first and second composite rods;
forming a spacer between the ends of the first and second composite rods, the spacer comprising a composite material and having first and second ends;
removing material from an outer surface of the composite material of the spacer adjacent each of the first and second ends of the spacer to form at least one shoulder on the outer surface of each of the first and second ends of the spacer;
applying a first clamp device to the end of the first composite rod and applying a second clamp device to the end of the second composite rod, each of the first and second clamp devices having first and second shoulders on an inner surface of each of the first and second clamp devices;
wherein respective first and second shoulders on the first clamp device are adapted to engage the shoulder on the end of the first composite rod and the shoulder on the first end of the spacer;
and wherein respective first and second shoulders on the second clamp device are adapted to engage the shoulder on the end of the second composite rod and the shoulder on the second end of the spacer;
connecting the first and second clamp devices with the spacer by clamping the end of the first composite rod and the first end of the spacer in the first clamp device, such that respective first and second shoulders on the first clamp device engage with the shoulder on the first composite rod and with the shoulder on the first end of the spacer, and clamping the end of the second composite rod and the second end of the spacer in the second clamp device, such that respective first and second shoulders on the second clamp device engage with the shoulder on the second composite rod and with the shoulder on the second end of the spacer; and
bonding the first and second composite rods and the spacer to the first and second clamp devices with an adhesive.

24. The method of claim 23, wherein the shoulders on the first and second composite rods and on the spacer are formed by a machining step performed on the outer surface of the first and second composite rods and the spacer, the machining step being selected from the group consisting of grinding, abrading, and cutting the outer surface of the first and second composite rods and the spacer.

25. The method of claim 23, wherein the shoulders have flat surfaces extending radially in a direction perpendicular to an axis of the first and second composite rods and the spacer.

26. The method of claim 23, wherein the shoulders are annular, extending around at least a part of the circumference of the first and second composite rods and the spacer.

27. The method of claim 23, wherein the outer diameter of the spacer and the first and second clamp devices is substantially uniform.

28. The method of claim 23, wherein the first and second clamp devices clamp opposite ends of the spacer at respective inner ends of the clamp devices, and clamp respective ends of the first and second rods at respective outer ends of the clamp devices.

29. The method of claim 23, wherein the spacer comprises a channel adapted to receive the optical fibre, and wherein the method includes the step of inserting the optical fibre into the channel and closing the channel around the optical fibre by laying composite material in the channel over the optical fibre.

30. The method of claim 23, including removing material from an outer surface of the material surrounding the optical fibre on each of the first and second composite rods to expose a length of the optical fibre embedded in the first and second composite rods.

31. The method of claim 23, wherein the step of removing material from the outer surface of the composite material to form the shoulder is performed before the step of applying the clamp device.

32. The method of claim 23, wherein the optical fibre is covered by a metal tube slid over the ends of the optical fibres after connection of the optical fibres between the first and second composite rods.

33. A connection assembly comprising:
a first composite rod having an end and a second composite rod having an end, the first and second composite rods each being suitable for insertion into a wellbore of an oil or gas well and each of the first and second composite rods comprising an optical fibre embedded within a composite material, wherein the ends of the first and second composite rods each comprise a length of optical fibre extending from a length of composite material;
the ends of the first and second rods each having at least one shoulder extending radially into the outer surface of the composite material surrounding the optical fibre;
wherein the lengths of optical fibre extending from the ends of each of the first and second composite rods are connected between the ends of the first and second rods to form a continuous optical fibre conduit between the first and second composite rods; a first clamp device applied to an end of the first composite rod and a second clamp device applied to the end of the second composite rod, each of the first and second clamp devices having at least one shoulder engaged with a respective shoulder on each of the first and second composite rods;
a spacer comprising a composite material and first and second ends, the spacer surrounding the continuous optical fibre conduit extending between the first and second composite rods, the spacer having at least one shoulder on the outer surface of each of the first and second ends of the spacer engaged with a shoulder on one of the first and second clamp devices, and wherein the first clamp device clamps the first end of the spacer to the first composite rod, and wherein the second clamp device clamps the second end of the spacer to the second clamp device; and
wherein the first and second rods and the spacer are bonded to the first and second clamp devices with an adhesive.

34. The connection assembly of claim 33, wherein each shoulder on the first and second clamp devices and the spacer has at least one flat face which is perpendicular to an axis of the first and second composite rods.

35. The connection assembly of claim 33, wherein each shoulder is annular.

36. The connection assembly of claim 33, wherein the continuous optical fibre conduit surrounded by the spacer is encased in a metal tube and wherein the metal tube is surrounded by composite material.

37. The connection assembly of claim 33, wherein the first and second clamp devices are formed from a metal selected from a group consisting of titanium and alloys of titanium.

38. The connection assembly of claim 33, wherein the outer diameter of the first and second clamp devices is within 10% of the outer diameter of the first and second rod.

39. The connection assembly of claim 33, wherein the spacer comprises a channel, and wherein the optical fibre is received within the channel.

40. A method for making a connection between an end of a first composite rod and an end of a second composite rod, the first and second composite rods each being suitable for insertion into a wellbore of an oil or gas well and each rod comprising an optical fibre embedded within a composite material, wherein the ends of the first and second composite rods each comprise an exposed length of optical fibre extending from a length of composite material, the method comprising:
machining material from the outer surface of the composite material surrounding the optical fibre adjacent the ends of the first and second composite rods to form at least one shoulder on the outer surface of the composite material of each of the first and second composite rods;
connecting the optical fibres extending from the ends of the first and second composite rods to form a continuous optical fibre conduit between the first and second composite rods;
forming a spacer between the ends of the first and second composite rods, the spacer comprising a composite material and having first and second ends;
machining material from an outer surface of the composite material of the spacer adjacent each of the first and second ends of the spacer to form at least one shoulder on the outer surface of each of the first and second ends of the spacer;
applying a first clamp device to the end of the first composite rod and applying a second clamp device to the end of the second composite rod, each of the first and second clamp devices having first and second shoulders on an inner surface of each of the first and second clamp devices;
wherein respective first and second shoulders on the first clamp device are adapted to engage the shoulder on the end of the first composite rod and the shoulder on the first end of the spacer;
and wherein respective first and second shoulders on the second clamp device are adapted to engage the shoulder on the end of the second composite rod and the shoulder on the second end of the spacer;
connecting the first and second clamp devices with the spacer by clamping the end of the first composite rod and the first end of the spacer in the first clamp device, such that respective shoulders on the first clamp device engage with the shoulder on the first composite rod and with the shoulder on the first end of the spacer, and clamping the end of the second composite rod and the second end of the spacer in the second clamp device, such that respective shoulders on the second clamp device engage with the shoulder on the second composite rod and with the shoulder on the second end of the spacer; and
bonding the first and second composite rods and the spacer to the first and second clamp devices with an adhesive;
wherein the shoulders on the first and second composite rods and on the spacer are formed by a machining step performed on the outer surface of the first and second composite rods and the spacer, the machining step being selected from the group consisting of grinding, abrading, and cutting the outer surface of the first and second composite rods and the spacer;
wherein the shoulders on the spacer and on the first and second composite rods have flat surfaces which engage with flat surfaces on the shoulders of the first and second clamp devices.

41. The method of claim 40, wherein the optical fibre is covered by a metal tube slid over the ends of the optical fibres after connection of the optical fibres between the first and second composite rods, and wherein the metal tube is surrounded by composite material within the spacer.

42. The method of claim 41, wherein the spacer comprises a channel adapted to receive the optical fibre, and wherein the method includes the step of inserting the optical fibre into the channel and closing the channel around the optical fibre by laying composite material in the channel over the optical fibre.
